(19) United States
(12) Patent Application Publication
(10) Pub. No.: US 2014/0192341 A1
(43) Pub. Date: Jul. 10, 2014

(54) FIXTURE PLANARITY EVALUATION METHOD

(71) Applicant: INTERNATIONAL BUSINESS MACHINES CORPORATION, Armonk, NY (US)

(72) Inventors: Sarah H. Knickerbocker, Hopewell Junction, NY (US); Jerry Allen Gorrell, Lagrangeville, NY (US); Christopher Lee Tessler, Poughquag, NY (US)

(73) Assignee: INTERNATIONAL BUSINESS MACHINES CORPORATION, Armonk, NY (US)

(21) Appl. No.: 13/735,103

(22) Filed: Jan. 7, 2013

(51) Int. Cl. G01B 5/28; G01B 11/30

(52) U.S. Cl. CPC G01B 5/28; G01B 11/30
USPC 356/36; 33/533

(57) ABSTRACT

Methods for determining the planarity of two components of a semiconductor processing tool, such as a 3D wafer bonder are disclosed. The two components may be fixtures, chucks, or platens of the tool. A test wafer comprising multiple solder balls is compressed and the deformity of multiple solder balls is measured to assess the planarity of the tool. The measurement of the deformed solder balls may be performed manually, or with an automated wafer inspection tool, which may use lasers to measure the height of each solder ball. The planarity of the two components is computed based on the height of the deformed solder balls.

### FIELD OF THE INVENTION

The present invention relates generally to semiconductor fabrication, and more particularly to methods for evaluating the planarity of fixtures, platens and chucks.

### BACKGROUND OF THE INVENTION

The 3D Bonder is a multi-million dollar tool which is used to bond either a glass plate to a wafer or a wafer to another wafer. This tool is critical for the 3D chip-stack program and its proper operation is essential to the success of the technology. In order to bond a wafer and a glass plate, for instance, an adhesive is placed on a wafer and/or glass plate and the two are aligned to one another and bonded under high temperature and pressure. The platens and the fixtures or chucks that secure wafers in the bonder need to be parallel and flat to within several microns. If they are not parallel or flat, voiding can occur between the wafer and the glass plate or in the case of a wafer to wafer bond, incomplete bonding can result. It is therefore desirable to have improved methods for evaluating fixture, platen or chuck planarity.

### SUMMARY OF THE INVENTION

In one embodiment, a method of measuring planarity of two components of a semiconductor processing tool is provided. The method comprises compressing a wafer with the semiconductor processing tool comprising a first fixture and a second fixture; wherein the wafer comprises a plurality of solder balls on a surface of the wafer, measuring deformity of multiple solder balls from the plurality of solder balls, and determining planarity of the first fixture with respect to the second fixture.

In another embodiment, a method of measuring planarity of two components of a semiconductor processing tool is provided. The method comprises compressing a first wafer with the semiconductor processing tool, wherein the first wafer is secured in a first fixture, and wherein the first wafer comprises a plurality of solder balls on a surface of the first wafer, and wherein a second fixture holds a second wafer, such that the second wafer compresses the solder balls of the first wafer, measuring deformity of multiple solder balls from the plurality of solder balls; and determining the planarity of the first fixture with respect to the second fixture.

In another embodiment, a method of measuring planarity of two components of a semiconductor processing tool is provided. The method comprises heating a wafer to a temperature ranging from 260 degrees Celsius to 275 degrees Celsius, wherein the wafer comprises between 90,000 and 100,000 solder balls on a surface of the wafer, compressing a wafer secured in a first fixture of the semiconductor processing tool, wherein the wafer is compressed with a second fixture of the semiconductor processing tool, measuring deformity of multiple solder balls on the wafer; and determining planarity of the first fixture with respect to the second fixture.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

Often, similar elements may be referred to by similar numbers in various figures (FIGs) of the drawing, in which case typically the last two significant digits may be the same, the most significant digit being the number of the drawing figure (FIG). Furthermore, for clarity, some reference numbers may be omitted in certain drawings.

FIG. 1 shows a top-down view of a test wafer in accordance with embodiments of the present invention.

FIG. 2 shows a side view of a test wafer in accordance with embodiments of the present invention.

FIG. 3 shows use of a test wafer in accordance with embodiments of the present invention.

FIG. 4 shows an example of a test wafer indicating good planarity.

FIG. 5 shows an example of a test wafer indicating poor planarity.

FIG. 6 shows an example of a computation of planarity.

FIG. 7 is a flowchart indicating process steps for an embodiment of the present invention.

### DETAILED DESCRIPTION

In embodiments of the present invention, the parallelism or flatness of a bonder, solder transfer tool or any other tool that requires two highly parallel surfaces and its associated chucks, platens, and other fixtures is determined. A wafer with an array of solder balls on its surface is placed between the two fixtures within the tool, and compressed. The height of the solder balls is then measured across the wafer and the degree of flatness or parallelism across the wafer is determined.

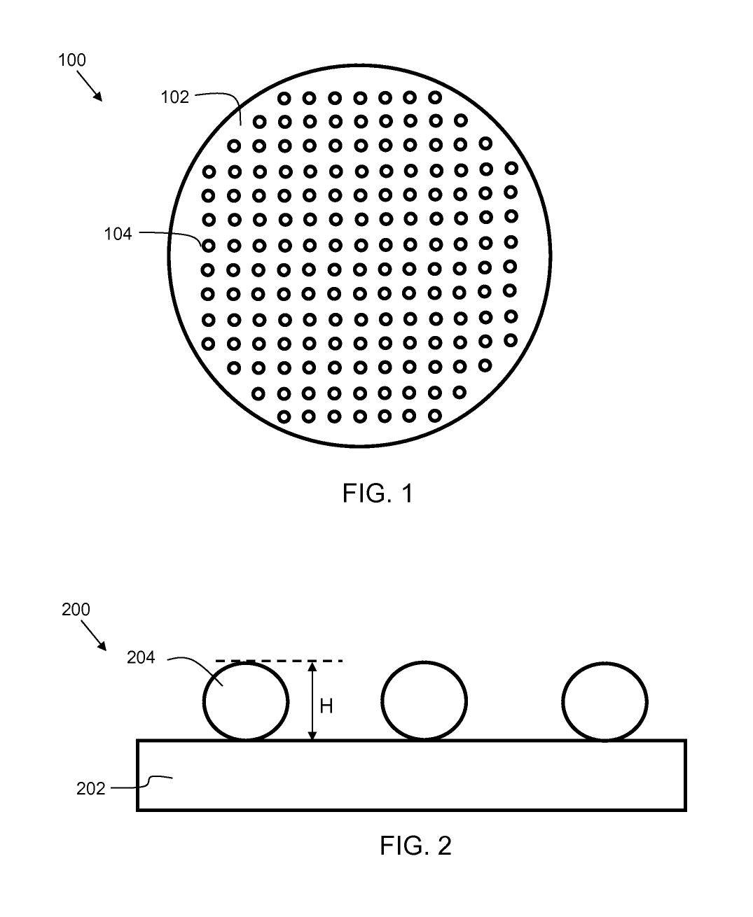

FIG. 1 shows a top-down view of a test wafer 102 in accordance with embodiments of the present invention. Wafer 102 may have a diameter of 300 millimeters, although wafers of other diameters may be used. Wafer 102 is a substrate, and may be comprised of silicon, germanium, or other semiconductor material. The wafer comprises a plurality of solder balls 104 on one surface. The solder balls 104 may be comprised of a lead and tin alloy, such as Pb/Sn (97/3). In other embodiments, the solder balls may be lead-free, and may comprise a SnAg (tin-silver), SnCu (tin-copper) or SnAgCu (tin-silver-copper) based alloy as well as many others. In some embodiments, a low-lead solder may be used, such as Sn97.5PblAg1.5. In some embodiments, there may be between 12 and 48 solder balls 104 disposed on wafer 102. In other embodiments, there may be between 1,000 and 5,000 solder balls 104 disposed on wafer 102. In other embodiments, there may be between 80,000 and 200,000 solder balls 104 disposed on wafer 102. In other embodiments, there may be between 80,000 and 2,000,000 solder balls 104 disposed on wafer 102. In other embodiments, there may be between 500,000 and 200,000 solder balls 104 disposed on wafer 102. In other embodiments, many millions of solder balls may be used on wafer 102. The decision about how many solder balls to use may depend in part on the measuring method and the amount of force available to deform the balls. For manual measuring with a microscope, a lower number of solder balls is appropriate. For measuring with an automated measuring tool, a larger number of solder balls can provide increased resolution in determining the planarity of the tool components. For the purposes of this disclosure, a “component” may refer to a fixture, chuck, or platen of a semiconductor processing tool.

FIG. 2 shows a side view of a test wafer 202 in accordance with embodiments of the present invention. As stated previously, similar elements may be referred to by similar numbers in various figures (FIGs) of the drawing, in which case typically the last two significant digits may be the same. For example, wafer 202 of FIG. 2 is similar to wafer 102 of FIG. 1. Solder balls 204 may be controlled collapse chip connection (C4) solder balls that are deposited onto wafer 202. Wafer 202 does not need to contain any functional electronic circuits. The solder balls 204 may be deposited in a uniform pattern on the wafer 202. Each solder ball 204 has a height H. In some embodiments, H ranges from about 50 micrometers to about 100 micrometers. In other embodiments, H ranges from about 70 micrometers to about 120 micrometers. In still other embodiments, H ranges from about 25 micrometers to about 40 micrometers.

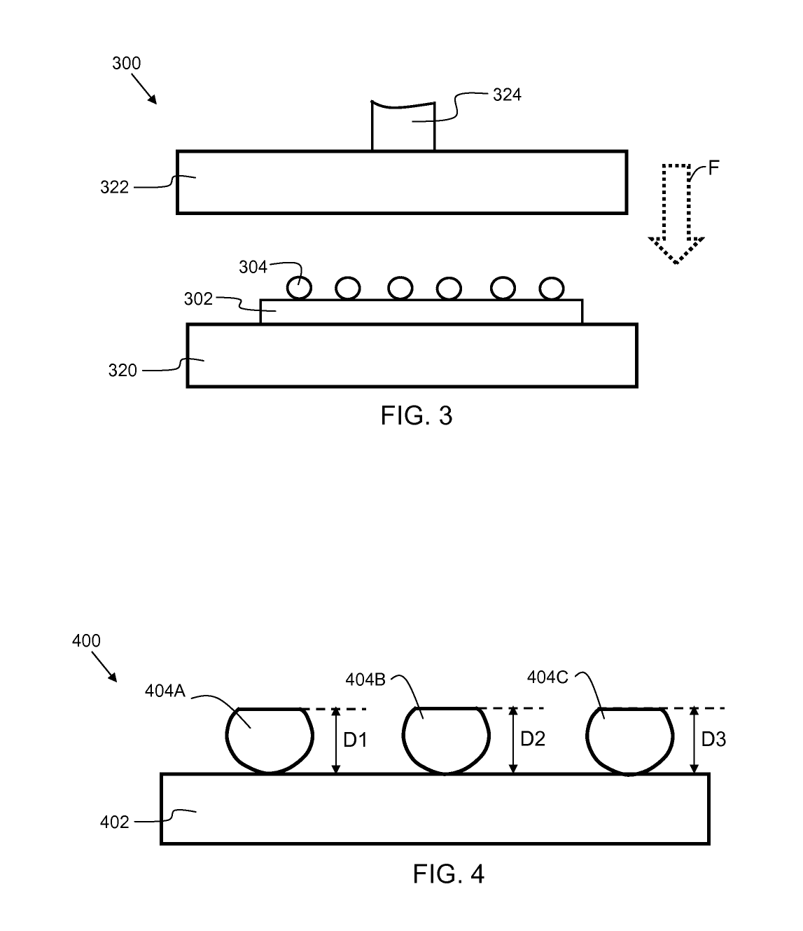

FIG. 3 shows use of a test wafer in accordance with embodiments of the present invention. A lower fixture 320 (e.g. a chuck, platen, or other wafer-securing apparatus) secures test wafer 302, which comprises a plurality of solder balls 304. An upper fixture 322 may be connected to a shaft 324, which exerts a downward force F on the solder balls. In some embodiments, the downward force F ranges from about 1 kilo-Newton to 1.5 kilo-Newtons. In other embodiments, the downward force F ranges from about 1.8 kilo-Newtons to 2.4 kilo-Newtons. The decision regarding the amount of force depends on various factors, such as the number of solder balls 304 disposed on the wafer 302 as well as the temperature. With a higher number of solder balls on the test wafer, more force may be needed. Similarly, with fewer solder balls on the test wafer, less force may be needed. The material used for the solder balls also is a factor, as well as the wafer temperature at which the compression occurs. Using a softer solder material and/or an elevated compression temperature may reduce the amount of force required. An important advantage of embodiments of the present invention is that it allows planarity testing at the operation temperature of the device. In comparison, prior art planarity checks using pressure paper are performed at room temperature. Due to thermal expansion of components, an ambient temperature planarity check may not reveal a planarity issue that occurs at the operating temperature of the tool. Preferably, the temperature used for the test is one where the solder balls are soft, but not melted, such that they will easily deform when compressed by upper fixture 322. In some embodiments, the wafer is heated to a temperature ranging from about 100 degrees Celsius to about 150 degrees Celsius prior to compression. In other embodiments, the wafer is heated to a temperature ranging from about 180 degrees Celsius to about 275 degrees Celsius prior to compression. In one embodiment, the wafer is heated to a temperature ranging of about 270 degrees Celsius. In other embodiments, the compression is performed at a cooler-than ambient temperature. In some embodiments, the compression is performed at a temperature below freezing (below 0 degrees Celsius).

FIG. 4 shows an example of a test wafer 402 indicating good planarity. Solder ball 404A is deformed to a height D1, where D1 is less than the original height of an uncompressed solder ball (see H of FIG. 2). In some embodiments, height D1 may be 20 to 30 micrometers less than the original height H. Similarly, solder ball 404B is compressed to a height D2, and solder ball 404C is compressed to a height D3. In this embodiment, heights D1, D2, and D3 are within a predetermined range of each other. For example, solder balls 404A, 404B, and 404C may be compressed to a height of 30 micrometers, and D1=D2=D3. In practice, D1 and D3 might not be equal, but may be within a predetermined range of each other (e.g. within 5 micrometers of each other). If the difference between MAX(D1,D2,D3) and MIN(D1,D2,D3) is less than the predetermined limit, then the tool may be deemed to be planar, or within a specified tolerance.

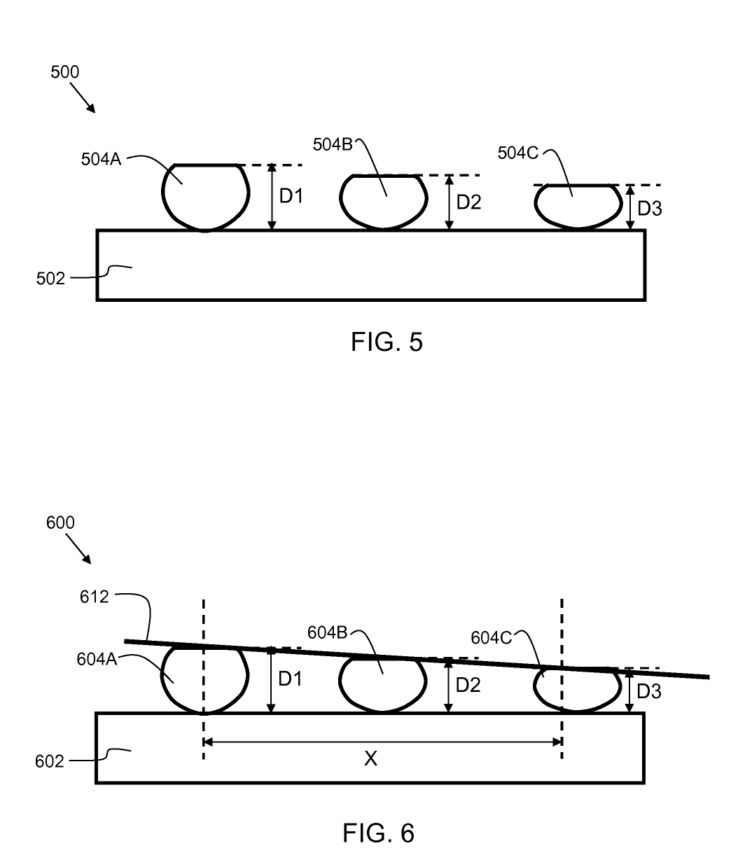

FIG. 5 shows an example of a test wafer 502 indicating poor planarity. Solder ball 504A is compressed to a height Dl. Similarly, solder ball 504B is compressed to a height D2, and solder ball 504C is compressed to a height D3. In this example, D1>D2>D3. For example, D1 may be 40 micrometers, D2 may be 37 micrometers, and D3 may be 34 micrometers. Hence, in this example, the difference between MAX(D1,D2,D3) and MIN(D1,D2,D3) is 40−34=6, which exceeds an example predetermined threshold limit of 5, indicating that the tool (e.g. 3D bonder tool) is out of tolerance. Hence the difference between the height of the tallest and shortest solder ball may be a planarity value that is used to assess the planarity of a semiconductor processing tool. Note that while the aforementioned example uses three solder balls, in practice, more solder balls are used for determining the planarity of the tool fixtures.

FIG. 6 shows an example of a computation of planarity. Wafer 602 and its solder balls 604A, 604B and 604C are similar to that of FIG. 5. In this case, a planarity line 612 is computed that contacts the top both the shortest and the tallest solder ball. The distance X between two given solder balls is known or can be measured, and hence, the slope of planarity line 612 can be computed as rise over run, which is (D3-D1)/X. The slope (polarity and magnitude) of the planarity line 612 may be a planarity value that can be used to aid production personnel in determining the necessary adjustment to fixtures on the tool undergoing test/calibration to correct any planarity issues. By maintaining X as constant in all testing, the difference between the highest and the lowest of thousands of solder balls can be used to quantify planarity.

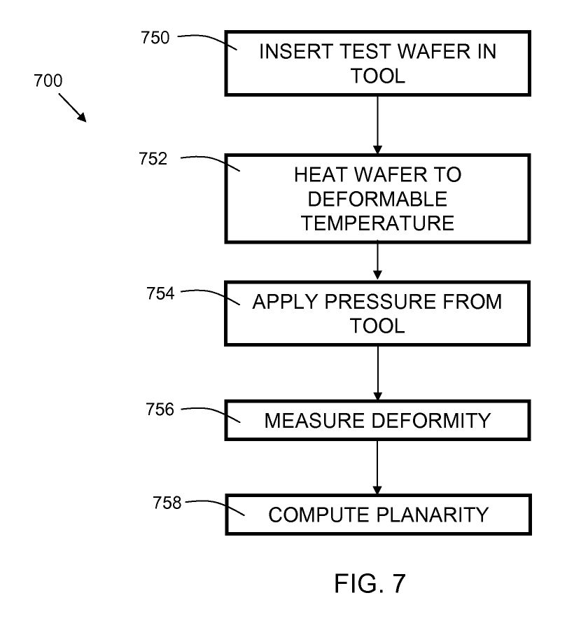

FIG. 7 is a flowchart 700 indicating process steps for an embodiment of the present invention. In process step 750, a test wafer (such as shown in FIG. 1) is inserted into a fixture (e.g. a chuck or other mounting apparatus) of a semiconductor processing tool undergoing test. The semiconductor processing tool may be a 3D wafer bonder or other tool requiring planarity between two fixtures. In optional process step 752, the wafer is heated to an elevated temperature, to soften the solder balls. Preferably the elevated temperature is near the operating temperature of the tool, and is of a temperature to make the solder balls soft, but not so hot as to melt them. In process step 754, the wafer is compressed with the tool (see FIG. 3). In some embodiments, the wafer may be inserted in a lower fixture, and compressed with an upper fixture. In other embodiments, the upper fixture may hold a second wafer, and the second wafer may be used to compress the solder balls on the test wafer. In some embodiments, the force may be applied for a duration ranging from 500 milliseconds to about 5 seconds. In process step 756, the deformity of the compressed solder balls is measured. This process may be performed manually, by viewing the solder balls with a microscope. Alternatively, a wafer inspection tool that typically uses lasers to measure the solder ball height may be used. A wafer inspection tool (laser measuring tool) can easily provide the location and height of the minimum and maximum deformity of the solder balls on the test wafer. One such wafer inspection tool is the Wafer Scanner, by Rudolph Technologies of Flanders, N.J. In such an automated wafer inspection tool, it is practical to use many thousands of solder balls on the test wafer, which improves the resolution of the planarity measurement, and may also be used to detect non-linear problems such as a warped fixture. In process step 758, the planarity of the tool is computed. In the simplest case, this computation may comprise subtracting the minimum deformed ball height from the maximum deformed ball height (e.g. D1-D3 in FIG. 5), and providing a planarity tolerance indication or warning if the difference exceeds a predetermined threshold. In other embodiments, an equation for a planarity line may be computed (see 612 of FIG. 6). The slope of the planarity line may be used to assist fabrication personnel in determining the appropriate course of action for rectifying the planarity issue. For example, the polarity and magnitude of the slope of the planarity line can indicate which way the tool fixture needs to be adjusted to improve the planarity (e.g. which side needs to be raised or lowered to improve the planarity). In other cases, chucks or fixtures may need to be further machined to improve their flatness.

Embodiments of the present invention provide for an improved method of determining the planarity of two components of a tool, such as a 3D wafer bonder. A test wafer comprising multiple solder balls is compressed and the deformity of multiple solder balls is measured to assess the planarity of the tool. This provides a cost-effective and time-efficient way to evaluate the planarity of such a tool. As these tools may cost millions of dollars, it becomes very important to have a way to qualify such a tool prior to taking delivery. Furthermore, methods disclosed herein can be periodically executed in-situ during fabrication to check the planarity of the tool throughout its life. For example, by periodically checking the planarity of a tool (e.g. monthly), the planarity can be monitored as the tool ages. Embodiments of the present invention may include other suitable metal alloys and other deformable materials, and the compression may take place at higher or lower temperatures than in the disclosed examples, which are intended on as an example, and are not meant to be limiting.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A method of measuring planarity of two components of a semiconductor processing tool comprising:
compressing a wafer with the semiconductor processing tool comprising a first fixture and a second fixture, wherein the wafer comprises a plurality of solder balls on a surface of the wafer;
measuring deformity of multiple solder balls from the plurality of solder balls; and
determining planarity of the first fixture with respect to the second fixture.

2. The method of claim 1, wherein the wafer comprises between 12 and 48 solder balls.

3. The method of claim 1, wherein the wafer comprises between 1,000 and 5,000 solder balls.

4. The method of claim 1, wherein the wafer comprises between 80,000 and 2,000,000 solder balls.

5. The method of claim 1, wherein the compressing occurs at a force ranging between 1 kilo-Newton and 1.5 kilo-Newtons.

6. The method of claim 1, wherein the compressing occurs at a force ranging between 1.8 kilo-Newtons and 2.4 kilo-Newtons.

7. The method of claim 1, wherein the wafer is heated to a temperature ranging from about 100 degrees Celsius to about 150 degrees Celsius prior to compression.

8. The method of claim 1, wherein the wafer is heated to a temperature ranging from about 180 degrees Celsius to about 275 degrees Celsius prior to compression.

9. The method of claim 1, wherein compressing a wafer comprises compressing a wafer comprising solder balls comprised of an alloy comprised of lead and tin.

10. The method of claim 1, wherein compressing a wafer comprises compressing a wafer comprising solder balls comprised of an alloy comprised of SnAg.

11. The method of claim 1, wherein compressing a wafer comprises compressing a wafer comprising solder balls comprised of an alloy comprised of SnCu.

12. The method of claim 1, wherein compressing a wafer comprises compressing a wafer comprising solder balls comprised of an alloy comprised of SnAgCu.

13. The method of claim 1, wherein compressing a wafer comprises compressing a wafer comprising solder balls having a height ranging between about 50 micrometers to about 100 micrometers.

14. The method of claim 1, wherein measuring deformity of multiple solder balls from the plurality of solder balls is performed via a microscope.

15. The method of claim 1, wherein measuring deformity of multiple solder balls from the plurality of solder balls is performed via an automated wafer inspection tool.

16. The method of claim 1, wherein determining planarity of the first fixture with respect to the second fixture comprises:
identifying the tallest solder ball on the wafer after the wafer is compressed;
identifying the shortest solder ball on the wafer after the wafer is compressed; and
subtracting the height of the shortest solder ball from the height of the tallest solder ball to compute a planarity value.

17. The method of claim 16, further comprising:
computing a planarity line; and
using the slope of the planarity line to determine if planarity of the first fixture with respect to the second fixture is within a desired tolerance range.

18. A method of measuring planarity of two components of a semiconductor processing tool comprising:
compressing a first wafer with the semiconductor processing tool, wherein the first wafer is secured in a first fixture, and wherein the first wafer comprises a plurality of solder balls on a surface of the first wafer, and wherein a second fixture holds a second wafer, such that the second wafer compresses the solder balls of the first wafer;
measuring deformity of multiple solder balls from the plurality of solder balls; and
determining the planarity of the first fixture with respect to the second fixture.

19. A method of measuring planarity of two components of a semiconductor processing tool comprising:
heating a wafer to a temperature ranging from 260 degrees Celsius to 275 degrees Celsius, wherein the wafer comprises between 90,000 and 100,000 solder balls on a surface of the wafer;
compressing a wafer secured in a first fixture of the semiconductor processing tool, wherein the wafer is compressed with a second fixture of the semiconductor processing tool;
measuring deformity of multiple solder balls on the wafer; and
determining planarity of the first fixture with respect to the second fixture.

20. The method of claim 19, wherein measuring deformity of multiple solder balls comprises using a laser measuring tool.
